(19) United States
(12) Patent Application Publication
(10) Pub. No.: US 2017/0286478 A1
(43) Pub. Date: Oct. 5, 2017

(54) METHOD AND COMPUTING DEVICE FOR MODIFYING A QUERY THAT INCLUDES AT LEAST ONE TEMPORAL EXPRESSION

(71) Applicant: Change Healthcare LLC, Alpharetta, GA (US)

(72) Inventor: Michael Altmann, Minneapolis, MN (US)

(73) Assignee: Change Healthcare LLC, Alpharetta, GA (US)

(21) Appl. No.: 15/086,633

(22) Filed: Mar. 31, 2016

(51) Int. Cl. G06F 17/30

(52) U.S. Cl. CPC G06F 17/30389

(57) ABSTRACT

A method, computer device and computer program product are provided to modify a query that includes at least one temporal expression to identify a point in time at which the query is to be reevaluated. In the context of a method, a modified query is constructed from the query that includes at least one temporal expression. The modified query also identifies a next point in time at which the result of the query is able to change. The method also executes the modified query to determine a result of the query and to also determine the next point in time at which the result of the query is able to change. The method further includes scheduling the modified query to again be executed at the next point in time at which the result of the query is able to change.

### TECHNOLOGICAL FIELD

An example embodiment of the present invention relates generally to the modification of a query that includes at least one temporal expression and, more particularly, to the modification of a query that includes at least one temporal expression to identify a point in time at which the query is to be reevaluated.

### BACKGROUND

A query may evaluate one or more expressions in order to determine a result. Although queries may evaluate a wide variety of expressions, clinical quality measures may be defined in terms of one or more logical expressions and may be evaluated by means of a query in order to measure and track the quality of the services that have been provided. Among other things, clinical quality measures may measure the ultimate outcomes, adherence to clinical guidelines, the efficient use of healthcare resources, etc.

Typically, a clinical quality measure may initially be expressed in human readable form, such as a clinical quality measure that serves to identify patients having an active diagnosis for depression or a diagnosis of bipolar disorder in the last ten days, a clinical quality measure that identifies patients between 60 and 75 years of age, or a clinical quality measure that identifies patients who had an outpatient or emergency department visit with a diagnosis of pharyngitis during a predefined measurement period with an antibiotic ordered on or within three days following the visit. The human readable form of these clinical quality measures may be converted by a developer into computer program code that, upon execution, evaluates information, such as the electronic health records, of a plurality of patients in order to identify the patients that satisfy the respective clinical quality measure. In this regard, the foregoing examples of clinical quality measures in the human readable form may be written by a developer using a form of language, such as clinical quality language (CQL), as follows:

```
[Diagnosis: “Depression”] where onset between today - 10 days and today
AgeInYearsAt(today) >= 50 and AgeInYearsAt(today) <= 75
define PharyngitisEncounters:
MeasurementPeriodEncounters E
  such that E.period ends before today - 3 days
  with Pharyngitis P such that
    Interval[P.onsetDateTime, P.abatementDate] includes E.petiod
    or P.onsetDateTime in E.period
```

The evaluation of the information relating to a patient for these clinical quality measures generally returns a Boolean value, e.g., true or false. While the computer program code that implements such clinical quality measures may be adequate for evaluating clinical quality measures at the current point in time, some clinical quality measures include temporal expressions that have a value that changes over time. However, the computer program code that implements the clinical quality measures does not generally evaluate the temporal expressions so as to determine when the value changed in the past or when the value will change in the future. In order to evaluate these temporal expressions, such as the temporal expressions representative of a clinical quality measure, at different points in time, developers had to write additional computer program code to be executed at each of the different times at which the temporal expressions were to be evaluated, thereby requiring additional work on behalf of the developer that served to limit or prevent the implementation of the temporal expressions, such as the temporal expressions representative of a clinical quality measure, by analysts or other individuals who were not trained and experienced in software development including the development of the computer program code necessary to implement the temporal expressions, both at the current time and at other points in time.

### BRIEF SUMMARY

A method, computing device and computer program product are provided in accordance with an example embodiment in order to modify a query that includes at least one temporal expression. In this regard, a method, computing device and computer program product are provided in accordance with an example embodiment in order to modify a query that includes at least one temporal expression so as to identify a point in time at which the query is to be evaluated. Thus, a developer need not write computer program code in order to evaluate the temporal expression(s) at each different point in time and, instead, the method, computing device and computer program product of an example embodiment may, during execution of the query at one point in time, determine the next point in time at which the query is to be executed. Thus, the query may be repeatedly executed with a method, computing device and computer program product of an example embodiment determining the next point in time at which the query is to be executed as part of the prior execution of the same query.

In accordance with one embodiment, a method is provided for modifying a query that includes at least one temporal expression to identify a point in time at which the query is to be reevaluated. The method includes constructing a modified query from the query that includes at least one temporal expression. The modified query that is constructed is also configured to define a manner in which a next point in time at which the result of the query is able to change is to be identified. The method also includes executing, with processing circuitry, the modified query to determine a result of the query and to also determine the next point in time at which the result of the query is able to change. The method further includes scheduling the modified query to again be executed at the next point in time at which the result of the query is able to change. As such, the method may refrain from execution of the modified query following the scheduling until the next point in time at which the result of the query is able to change.

The query may include a combination of two or more temporal expressions. In an example embodiment, the method executes the modified query so as to identify the next point in time from among a union of the points in time at which the result of the respective temporal expressions is able to change. The method of another example embodiment executes the modified query so as to identify the next point in time as an earliest point in time, subsequent to a current time, at which the result of any of the temporal expressions is able to change. The method of a further example embodiment executes the modified query so as to determine the next point in time as either a minimum or a maximum of the next points in time at which the results of the respective temporal expressions are able to change based upon a manner in which the two or more temporal expressions are combined.

The method of an example embodiment also includes newly receiving historical data to be evaluated by the query, defining a clock to have a value based upon a time associated with an earliest of the historical data and executing the modified query to determine the result based upon the data associated with a time that is no later than the value of the clock. In this regard, execution of the modified query also determines the next point in time at which the result of the query is able to change. The method of this example embodiment also includes advancing the value of the clock to equal the next point in time at which the result of the query is able to change and again executing the modified query to determine the result based upon the data associated with a time that is no later than the value of the clock following its advancement. The execution of the modified query also determines the next point in time at which the result of the query is able to change. The method of this example embodiment may repeat the advancement and execution until the next point in time that is determined is later than a current time.

In another example embodiment, a computing device is provided for modifying a query that includes at least one temporal expression to identify a point in time at which the query is to be reevaluated. The computing device includes processing circuitry configured to construct a modified query from the query that includes at least one temporal expression. The modified query that is constructed is also configured to define a manner in which a next point in time at which the result of the query is able to change is to be identified. The processing circuitry is also configured to execute the modified query to determine a result of the query and to also determine the next point in time at which the result of the query is able to change. The processing circuitry is further configured to schedule the modified query to again be executed at the next point in time at which the result of the query is able to change. As such, the processing circuitry may be configured to refrain from execution of the modified query following the scheduling until the next point in time at which the result of the query is able to change.

The query may include a combination of two or more temporal expressions. In an example embodiment, the processing circuitry is configured to execute the modified query so as to identify the next point in time from among a union of the points in time at which the result of the respective temporal expressions is able to change. The processing circuitry of another example embodiment is configured execute the modified query so as to identify the next point in time as an earliest point in time, subsequent to a current time, at which the result of any of the temporal expressions is able to change. The processing circuitry of a further example embodiment is configured to execute the modified query so as to determine the next point in time as either a minimum or a maximum of the next points in time at which the results of the respective temporal expressions are able to change based upon a manner in which the two or more temporal expressions are combined.

The processing circuitry of an example embodiment is also configured to newly receive historical data to be evaluated by the query, define a clock to have a value based upon a time associated with an earliest of the historical data, and execute the modified query to determine the result based upon the data associated with a time that is no later than the value of the clock. The execution of the modified query also determines the next point in time at which the result of the query is able to change. The processing circuitry of this example embodiment may be further configured to advance the value of the clock to equal the next point in time at which the result of the query is able to change and to again execute the modified query to determine the result based upon the data associated with a time that is no later than the value of the clock following its advancement. The execution of the modified query also determines the next point in time at which the result of the query is able to change. The advancement and execution may be repeated until the next point in time that is determined is later than a current time.

In a further example embodiment, a computer program product is provided that includes at least one non-transitory computer-readable storage medium for modifying a query that includes at least one temporal expression to identify a point in time at which the query is to be reevaluated. The at least one non-transitory computer-readable storage medium stores computer-executable instructions configured, when executed, to cause an apparatus to construct a modified query from the query that includes at least one temporal expression. The modified query that is constructed is also configured to define a manner in which a next point in time at which the result of the query is able to change is to be identified. The computer-executable instructions are also configured to execute the modified query to determine a result of the query and to also determine the next point in time at which the result of the query is able to change. The computer-executable instructions are further configured to schedule the modified query to again be executed at the next point in time at which the result of the query is able to change.

The query may include a combination of two or more temporal expressions. In an example embodiment, the computer-executable instructions are configured to execute the modified query so as to identify the next point in time from among a union of the points in time at which the result of the respective temporal expressions is able to change. The computer-executable instructions of another example embodiment are configured to execute the modified query so as to identify the next point in time as an earliest point in time, subsequent to a current time, at which the result of any of the temporal expressions is able to change. The computer-executable instructions of a further example embodiment are configured to execute the modified query so as to determine the next point in time as either a minimum or a maximum of the next points in time at which the results of the respective temporal expressions are able to change based upon a manner in which the two or more temporal expressions are combined.

The computer-executable instructions of an example embodiment are further configured to newly receive historical data to be evaluated by the query, define a clock to have a value based upon a time associated with an earliest of the historical data and execute the modified query to determine the result based upon the data associated with a time that is no later than the value of the clock. The execution of the modified query also determines the next point in time at which the result of the query is able to change. The computer-executable instructions of this example embodiment may be further configured to advance the value of the clock to equal the next point in time at which the result of the query is able to change and to again execute the modified query to determine the result based upon the data associated with a time that is no later than the value of the clock following its advancement. The execution of the modified query also determines the next point in time at which the result of the query is able to change. The advancement and execution may be repeated until the next point in time that is determined is later than a current time.

### BRIEF DESCRIPTION OF THE DRAWINGS

Having thus described certain example embodiments of the invention in general terms, reference will now be made to the accompanying drawings, which are not necessarily drawn to scale, and wherein:

FIG. 1 is a block diagram of a computing device that may be specifically configured in accordance with an example embodiment of the present invention;

FIG. 2 is a flow chart illustrating operations performed, such as by the computing device of FIG. 1, in accordance with an example embodiment of the present invention; and

FIG. 3 is a flow chart illustrating operations performed, such as by the computing device of FIG. 1, in order to review historical data in accordance with another example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Further, the apparatus and method of example embodiments of the present invention will be primarily described in conjunction with medical-imaging applications. It should be understood, however, that the apparatus and method may be utilized in conjunction with a variety of other applications, both in the medical industry and outside the medical industry. Like numbers refer to like elements throughout.

A method, computing device and computer program product are provided in accordance with an example embodiment in order to modify a query that includes at least one temporal expression. The query may evaluate a wide variety of temporal expressions. In an example embodiment, however, the query determines a clinical quality measure by the evaluation of one or more temporal expressions that define the clinical quality measure.

A temporal expression is an expression having a value that varies over time. In other words, a temporal expression is an expression that is a function of the time at which it is evaluated. For example, if a patient has a diagnosis of depression with an onset of Jan. 3, 2016, a temporal expression that identifies whether the patient has an active diagnosis for depression in the last ten days is false in instances in which the current day is prior to Jan. 3, 2016, is true when evaluated for the current day being from Jan. 3 to Jan. 13, 2016 and again is false when evaluated for the current day being after Jan. 13, 2016. As another example, if a patient turns 50 years of age on Jan. 4, 2016, the temporal expression to determine whether the patient is at least 50 years of age would be false when evaluated for a current day prior to Jan. 4, 2016, but would be true when evaluated when the current day is on or after Jan. 4, 2016.

The query may include two or more temporal expressions, each of which varies in accordance with time. For example, the foregoing temporal expressions may be combined to define a query that identifies instances in which a patient is more than 50 years of age and has received a diagnosis of depression within the last ten days. In such an instance, the result would be false when evaluated for the current day being prior to Jan. 4, 2016 (as the patient was not yet 50 years of age), true when evaluated with the current day being between Jan. 4, 2016 and Jan. 13, 2016, and false when evaluated for the current day being after Jan. 13, 2016 (since the diagnosis of depression was more than ten days ago).

The temporal expressions evaluated by a query may be various types of temporal expressions including Boolean expression or numeric functions of time. A query can combine two or more temporal expressions in various manners, such as by applying “and” and “or” operations with respect to Boolean functions and various arithmetic operations, such as addition, to numeric functions of time. Regardless of the type of temporal expression, the temporal expressions are generally piecewise constant such that the combination of two or more temporal expressions is also generally piecewise constant, as demonstrated by the foregoing examples.

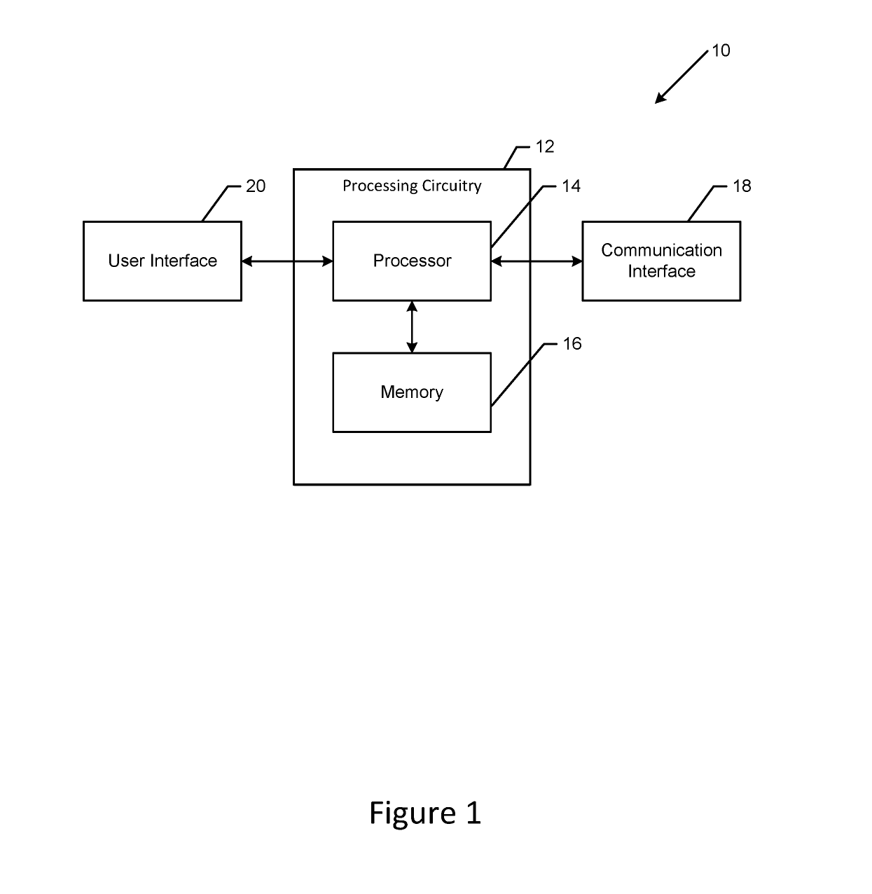

The computing device of an example embodiment may be embodied by one or more servers, computer workstations, desktop or laptop computers or other computing apparatus. Regardless of the manner in which the computing device is embodied, the computing device of an example embodiment may be configured as shown in FIG. 1. In this example embodiment, the computing device 10 includes or is otherwise in communication with processing circuitry 12 that is configurable to perform functions in accordance with one or more example embodiments disclosed herein. In this regard, the processing circuitry may be configured to perform and/or control performance of one or more functionalities of the computing device in accordance with various example embodiments, and thus may provide means for performing functionalities of the computing device. The processing circuitry may be configured to perform data processing, application execution and/or other processing and management services according to one or more example embodiments.

In some example embodiments, the processing circuitry 12 may include a processor 14 and, in some embodiments, such as that illustrated in FIG. 1, may further include memory 16. The processing circuitry may optionally be in communication with or otherwise control a communication interface 18 and, in some embodiments, a user interface 20. As such, the processing circuitry may be embodied as a circuit chip (e.g., an integrated circuit chip) configured (e.g., with hardware, software or a combination of hardware and software) to perform operations described herein.

The processor 14 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor may comprise a plurality of processors. The plurality of processors may be in operative communication with each other and may be collectively configured to perform one or more functionalities of the computing device 10 as described herein. The plurality of processors may be embodied on a single computing device or distributed across a plurality of computing devices collectively configured to function as the computer system. In some example embodiments, the processor may be configured to execute instructions stored in the memory 16 or otherwise accessible to the processor. As such, whether configured by hardware or by a combination of hardware and software, the processor may represent an entity (e.g., physically embodied in circuitry—in the form of processing circuitry 12) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform one or more operations described herein.

In some example embodiments, the memory 16 may include one or more non-transitory memory devices such as, for example, volatile and/or non-volatile memory that may be either fixed or removable. In this regard, the memory may comprise a non-transitory computer-readable storage medium. It will be appreciated that while the memory is illustrated as a single memory, the memory may comprise a plurality of memories. The plurality of memories may be embodied on a single computing device or may be distributed across a plurality of computing devices collectively configured to function as the computing device 10. The memory may be configured to store information, data, applications, instructions and/or the like for enabling the computer system to carry out various functions in accordance with one or more example embodiments. For example, the memory may be configured to buffer input data for processing by the processor 14. Additionally or alternatively, the memory may be configured to store instructions for execution by the processor. As yet another alternative, the memory may include one or more databases that may store a variety of files, contents or data sets, such as the pre-existing patient records discussed below. Among the contents of the memory, applications may be stored for execution by the processor in order to carry out the functionality associated with each respective application. In some cases, the memory may be in communication with one or more of the processor, user interface, or communication interface 18 via a bus or buses for passing information among components of the computing device.

The user interface 20 may optionally be in communication with the processing circuitry 12 to receive an indication of a user input at the user interface and/or to provide an audible, visual, mechanical or other output to the user. As such, the user interface may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In embodiments in which the computing device 10 is implemented on a server, aspects of the user interface may be limited, or the user interface may even be eliminated. For example, the computing device may act as a server or host device, with a user interface provided by a client application.

The communication interface 18 may include one or more interface mechanisms for enabling communication with other devices and/or networks, such as with healthcare facilities or databases that store patient data. In some cases, the communication interface may be any means such as a device or circuitry embodied in either hardware, or a combination of hardware and software that is configured to receive and/or transmit data from/to a network and/or any other device or module in communication with the processing circuitry 12. By way of example, the communication interface may be configured to enable the computing device 10 to communicate with the healthcare facilities or various databases via a wireless network, such as a wireless local area network (WLAN), cellular network, and/or the like. Additionally or alternatively, the communication interface may be configured to enable the computing device to communicate with the healthcare facilities or the various databases via a wireline network. In some example embodiments, the communication interface may be configured to enable communication via the internet. Accordingly, the communication interface may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described computing device 10 configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

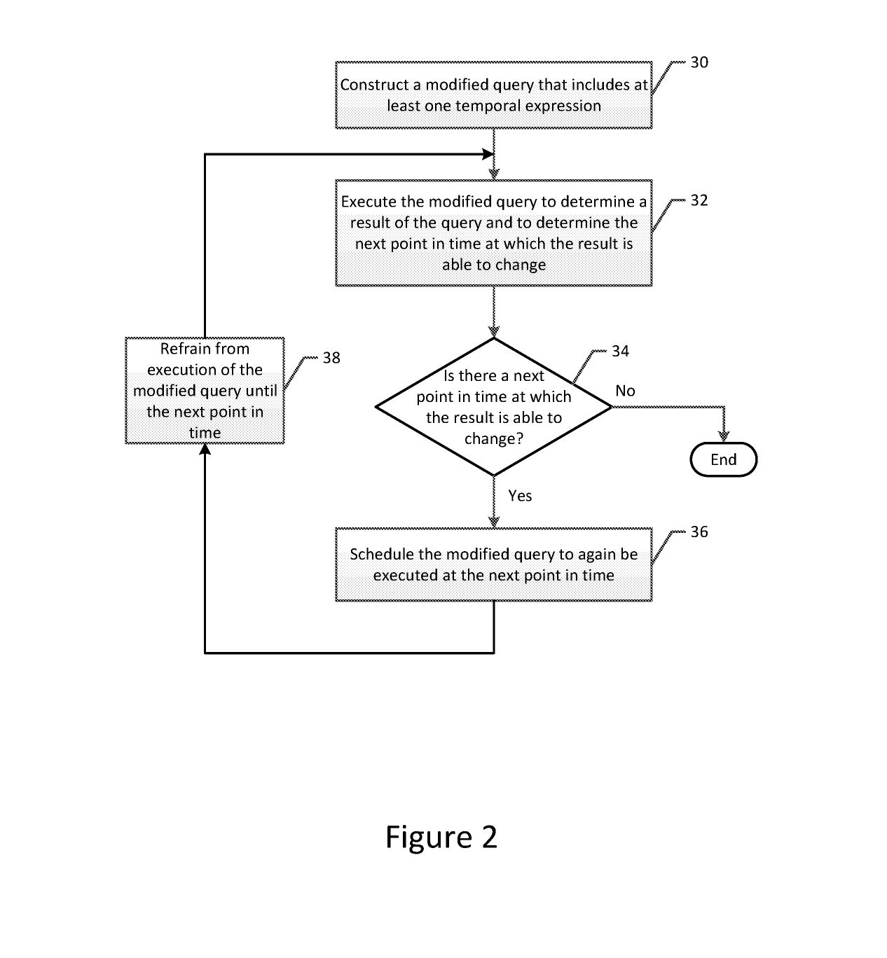

Referring now to FIG. 2, the operations performed in order to modify a query that includes at least one temporal expression so as to identify a point in time at which the query is to be reevaluated are depicted. In response to the receipt of a query, such as a query to determine a clinical quality measure, the computing device 10 includes means, such as the processing circuitry 12, e.g., the processor, 14, or the like, for constructing a modified query. See block 30. The modified query is not only configured to evaluate the original query at the point in time (the current time) at which the modified query is executed, but also to identify the next point in time at which the result of the query is able to change. In this regard, the modified query that is constructed is configured to define the manner in which a next point in time at which the result of the query is able to change is to be identified. The manner in which the next point in time is to be identified may be defined in various manners including, for example, by an analysis to identify the points in time at which the temporal expression(s) can change in value or by reference to a predefined set of points in time at which the temporal expression(s) can change in value, as described below. With respect to the foregoing example in which patients are evaluated to identify a patient who is older than 50 and who was diagnosed with depression within the last ten days, the next point in time that the query should be evaluated in an instance in which the execution of the query at the current time yielded a positive or true response is ten days following the date of the diagnosis of depression (since the result of the query will not change prior to that date). However, in an instance in which the result of the execution of the query at the current point in time is negative or false, the next point in time at which the result of the query is able to change is the day on which the patient turns 50 years of age if the patient is not yet 50 years of age, or tomorrow in an instance in which the patient is already 50 years of age.

The computing device 10, such as the processing circuitry 12, may be configured to define the manner in which the next point in time at which the result of the query is able to change is to be identified in various manners. For example, the computing device, such as the processing circuitry, of one example embodiment is configured to analyze the query including the one or more temporal expressions to identify the points in time at which the query is to be reevaluated, such as by identifying, for each temporal expression, those points in time at which the value of the respective temporal expression can change. The processing circuitry of this example embodiment may identify those points in time by applying logic to the query and the temporal expression(s) that comprise the query in order to identify the points in time.

With respect to the foregoing example in which the query relates to the identification of a patient that is at least 50 years of age and that has been diagnosed with depression within the last ten days, the processing circuitry 12 may identify the points in time at which the query is to be reevaluated by considering the temporal expression that requires the patient to be at least 50 years of age and determining that the points in time at which the value of this temporal expression can change are the annual birthdate of the patient. Thus, the points in time at which the result of the execution of the query can change include the annual birthdate of the patient, at least until the patient is determined to be 50 years of age. With respect to the temporal expression that requires the patient to have been diagnosed with depression in the last ten days, the processing circuitry also identifies the points in time at which the query is to be reevaluated to include each day until the patient is identified to have been diagnosed with depression, at which time the processing circuitry will identify the next point in time at which the query is to be evaluated to be 10 days following the date on which the patient was diagnosed with depression and thereafter on a daily basis. The processing circuitry may apply similar logic to other queries including other types of temporal expressions in order to identify each of the points in time at which the result of the query may change and, as a result, the query should be reevaluated.

Alternatively, the analyst, developer or other individual who initially defined the query, such as the query to determine a respective clinical quality measure, may also identify the plurality of points in time at which the results of the execution of the query is able to change, such as based upon the points in time at which each respective temporal expression is able to change in value. These points in time may be stored in association with the query, such as in memory 16 or in a database accessible by the computing device, and may be accessed by the computing device, such as the processing circuitry, in order to identify the next point in time relative to the current time at which the query should be evaluated.

The computing device 10 also includes means, such as the processing circuitry 12 or the like, for executing the modified query to determine a result of the query and to also determine the next point in time at which the results of the query are able to change. See block 32 of FIG. 2. The result of the query may be processed or otherwise acted upon in various manners. For example, the result of the modified query may be stored, such as for purposes of a report or other documentation. In addition or alternatively, the result of the modified query may be provided, such as to a healthcare professional, who may review the result and potentially act upon the result.

Temporal expressions may be written in various manners such that the next point in time at which the result of the query are able to change may be determined. For example, a temporal expression may be written in CQL as a function of time with a discrete set of points of time at which the value of the function changes. This function may be modeled as a set of intervals of time with respective associated values. In this regard, a Scala data structure representative of a temporal expression modeled utilizing interval arithmetic may be written as:
case class FunctionOfTime[T](initialValue: T, values: Seq[(Date, T)])
   with the set of points of time at which the value of the function changes being represented by the Dates.

As an example of such a function of time, consider the situation in which there are two movies playing at a theater, at overlapping times in two rooms. Star Wars has 55 viewers and ran from 300 minutes ago until now. As a result, the graph of attendance for Star Wars is a table function that is zero most of the time and is 55 for the period from 300 minutes ago until now. The second movie is Dead Poets, which had 13 viewers and ran from 400 minutes ago to 200 minutes ago. Assuming that the attendance at the theater is 0 when a movie is not playing, the total attendance at the theater is a function of time that was 0 people at and prior to 401 minutes ago. The attendance then changes to 13 people at 400 minutes ago, jumps to 68 people when Star Wars started 300 minutes ago, drops to 55 people at 200 minutes ago and will change to 0 people starting now and will be 0 into the future until another movie begins. This temporal expression may be logically expressed as follows:

```
class FunctionOverTimeSpec {
  val m1 = new Movie(“Star Wars”, 55, now.minus(300, minutes), now)
  val m2 = new Movie(“Dead Poets”, 13, now.minus(400, minutes),
now.minus(200, minutes))
  describe(“FunctionOverTime”) {
    describe(“When two movies overlap”) {
      it(“should have a total attendance that reflects the sum”) {
        val f1 = new FunctionOverTime[Option[Movie]](None, Seq((m1.start,
Some(m1)), (m1.stop, None)))
        val f2 = new FunctionOverTime[Option[Movie]](None, Seq((m2.start,
Some(m2)), (m2.stop, None)))
        // Add the two functions of time. Assume that when the movie is not
        // running the attendance is zero
        val total = f1.merge[Option[Movie], Int](f2, {
          case (thisMovie, thatMovie) => thisMovie.map(_.attendence).getOrElse(0) +
thatMovie.map(_.attendence).getOrElse(0)
        })
        // Verify how the total attendance varies with time
        assert(total(now.minus(401, minutes)) == 0)
        assert(total(now.minus(399, minutes)) == 13)
        assert(total(now.minus(299, minutes)) == 68)
        assert(total(now.plus(1, minutes)) == 0)
      }
    }
  }
}
```

As the foregoing example illustrates, the temporal expressions may represent a variety of parameters and need not only represent healthcare parameters or other patient data. However, the foregoing example is analogous to a situation in which a patient was diabetic from 300 days ago until now, and also had high blood pressure, from 400 days ago to 200 days ago. Temporal expressions similar to those set forth above can be defined to identify the periods of time when zero, one or both conditions were met for the patient.

Alternatively, a template expression may be written in CQL using temporal transitions. Thus, the expression in CQL is evaluated as a function that has a value and also defines the time at which the value will next change. For example, if a patient is 50 years of age and was born on January 4, the expression AgeInYearsAt(Current Time) would have a value of 50 and identify that the value next changes on January 4. Similarly, if a patient had a diagnosis of depression on January 3, evaluation of the expression [Diagnosis: “Depression”] where onset between today—10 days and today prior to January 3 would have a result of false and would identify the next time at which the value could change to be January 3. If the expression were evaluated between January 3 and January 13, the result would be true and the next time at which the value could change would be January 13. Further, if the expression were evaluated after January 13, the result would again be false and the value would never change again (based on the current patient data).

By way of example in which the template expressions are written in CQL using temporal transitions, a type, TimedBoolean, may be defined using Scala to hold its Boolean value and to identify the earliest time in the future at which the value may change as follows:

case class TimedBoolean(value: Boolean, change: DateTime) {
def this(value: Boolean) = { this(value, DateTime.MAX) }

As a more specific example, an expression of Age <50 may be expressed in Scala as Age(patient.birthDate, now) lt (50, years) which not only indicates that the patient is less than 50 years of age, but also when the expression will change, namely, birthdate, and, therefore, the next point in time at which the temporal expression is to be executed. In this regard, a Scala Age class may be defined as follows:

In addition, the Boolean operations of AND, OR and AND NOT may be defined as follows to permit two or more temporal expressions, each expressed, for example, as a type TimedBoolean, to be combined:

```
def and(other: TimedBoolean): TimedBoolean = {
  val nextChange = if (change.lt(other.change)) change else other.change
  new TimedBoolean(value && other.value, nextChange)
}
def and(other: Boolean): TimedBoolean = {
  new TimedBoolean(value && other, change)
}
def or(other: TimedBoolean): TimedBoolean = {
  val nextChange = if (change.lt(other.change)) change else other.change
  new TimedBoolean(value || other.value, nextChange)
def not( ): TimedBoolean = {
    new TimedBoolean(!value, change);
  }
}
```

Some temporal expressions identify the existence of a particular medical event. For example, the CQL expression of [Encounter: “Inpatient”] Enc determines whether an encounter having a type of “Inpatient” and an effective date prior to date. This type of temporal expression may be implemented in an example embodiment by wrapping each clinical event with a TimedBoolean that becomes true at the effective date of the clinical event. In Scala, the definition is:
case class TimedObject[T](obj: T, isEffective: TimedBoolean)

Similarly, CQL expressions work with collections of clinical events and allow CQL expressions to filter, join and test the emptiness of collections. These functions can be represented in Scala as follows:

```
case class TimedSeq[T](list: List[TimedObject[T]] = List( )) {
  def filter(f: Functionl[T, Boolean]): TimedSeq[T] = {
    new TimedSeq(list.map(x => new TimedObject(x.obj, x.isEffective.and(f(x.obj)))))
  }
  def exists(filter: T => TimedBoolean): TimedBoolean = {
    if (list.size == 0) new TimedBoolean(false) else list.map(x = >
x.isEffective.and(filter(x.obj))).reduce(_.or(_))
  }
  def nextChange( ): Date = {
    list.map(_.isEffective.change).reduce((t1, t2) => if (t1.lt(t2)) t1 else t2)
  }
  def union(other: TimedSeq[T]): TimedSeq[T] = {
    new TimedSeq[T](list.union(other.list))
  }
}
```

The computing device 10, such as the processing circuitry 12, is configured to determine the next point in time at which the value of the modified query can change in various manners. For example, the query of an example embodiment includes a combination of two or more temporal expressions. In this regard, the foregoing example in which the query identifies patients who are at least 50 years of age and who have been diagnosed with depression within the last 10 days includes two temporal expressions, one temporal expression relating to the age of the patient and another temporal expression relating to a recent diagnosis of depression. In an embodiment in which the query includes a combination of two or more temporal expressions, the computing device, such as the processing circuitry, may be configured to execute the modified query so as to identify the next point in time from among a union of the points in time at which the results of the respective temporal expressions are able to change. Thus, the computing device, such as the processing circuitry, may be configured to determine the points in time at which the result of a first temporal expression is able to change and the points in time at which the result of a second temporal expression is able to change and may, in turn, identify the points in time at which the result of the query is able to change based upon a combination of all of the points of time at which results of the individual temporal expressions are able to change.

In another embodiment in which the query includes a combination of two or more temporal expressions, the computing device 10, such as the processing circuitry 12, is configured to execute the modified query so as to identify the next point in time as the earliest point in time, subsequent to current time at which the modified query was executed, at which the result of any of the temporal expressions is able to change. For example, in an instance in which the points in time at which a first temporal expression is able to change are Jan. 5, 2016; Feb. 5, 2016 and Mar. 5, 2016 and the points in time at which a second temporal expression is able to change are Jan. 20, 2016; Feb. 20, 2016 and Mar. 20, 2016, the execution of the modified query on Feb. 1, 2016 will include the identification of Feb. 5, 2016 as the next point in time as Feb. 5, 2016 is the earliest point in time, subsequent to the time at which the modified query was executed, at which the result of either of the first or second temporal expressions is able to change.

In a further example embodiment in which the query includes a combination of two or more temporal expressions, the computing device 10, such as the processing circuitry 12, is configured to execute the modified query so as to determine the next point in time as either the minimum or the maximum of the next points in time at which the results of the respective temporal expressions are able to change based upon a manner in which the two or more temporal expressions are combined. In this regard, the minimum of the next points in time is the earlier of the next points in time at which the results of the respective temporal expressions are able to change, while the maximum of the next points in time is the later of the next points in time at which the results of the respective temporal expressions are able to change. In an embodiment in which the temporal expressions are alternative expressions, such as expressions joined by an OR operator, the processing circuitry may be configured to determine the next point in time as the minimum of the next points in time, that is, the earlier of the next points in time, at which the results of either of the temporal expressions are able to change. Thus, in the foregoing example, the next points in times at which the first and second temporal expressions are able to change are Feb. 5, 2016 and Feb. 20, 2016, respectively. In an embodiment in which the first and second temporal expressions are considered in the alternative, such as by being joined by the OR operator, the processing circuitry is configured to identify the minimum of the next points in time, that is, the earlier of the next points in time, e.g., Feb. 5, 2016 as the next point in time.

Conversely, in an embodiment in which the temporal expressions are additive or joint expressions, such as expressions joined by an AND operator, the processing circuitry 12 may be configured to determine the next point in time as the maximum of the next points in time, that is, the later of the next points in time, at which the results of either of the temporal expressions are able to change. Thus, in the foregoing example, the next points in times at which the first and second temporal expressions are able to change are Feb. 5, 2016 and Feb. 20, 2016, respectively. In an embodiment in which the first and second temporal expressions are considered in the aggregate, such as by being joined by the AND operator, the processing circuitry is configured to identify the maximum of the next points in time, that is, the later of the next points in time, e.g., Feb. 20, 2016 as the next point in time.

Regardless of the manner in which the next point in time is determined, if the execution of the modified query determines that there is no subsequent point in time at which the results of query can change, the process of executing the query may be terminated. However, in an instance in which the execution of the modified query determines that there is a next point in time at which the result of the query is able to change as shown in block 34, the computing device 10 includes means, such as the processing circuitry 12 or the like, for scheduling the modified query to again be executed at the next point in time at which the result of the query is able to change. See block 36. As such, the modified query may then be executed at the next point in time to determine the results of the query and to also determine a subsequent point in time at which the result of the query is able to change. This subsequent point in time may be scheduled and the process may be repeated until the result of the query is no longer able to change such that no next point in time is able to be determined. By determining the next point in time at which the result of the query is able to change and by scheduling the execution of the modified query based upon the next point in time that has been identified, the computing device, such as the processing circuitry, may repeatedly evaluate the query in an efficient manner and may conserve processing resources that may otherwise be unnecessarily consumed by the repeated evaluation of the query by refraining from execution of the modified query following its scheduling until the next point in time at which the result of the query is able to change. See block 38.

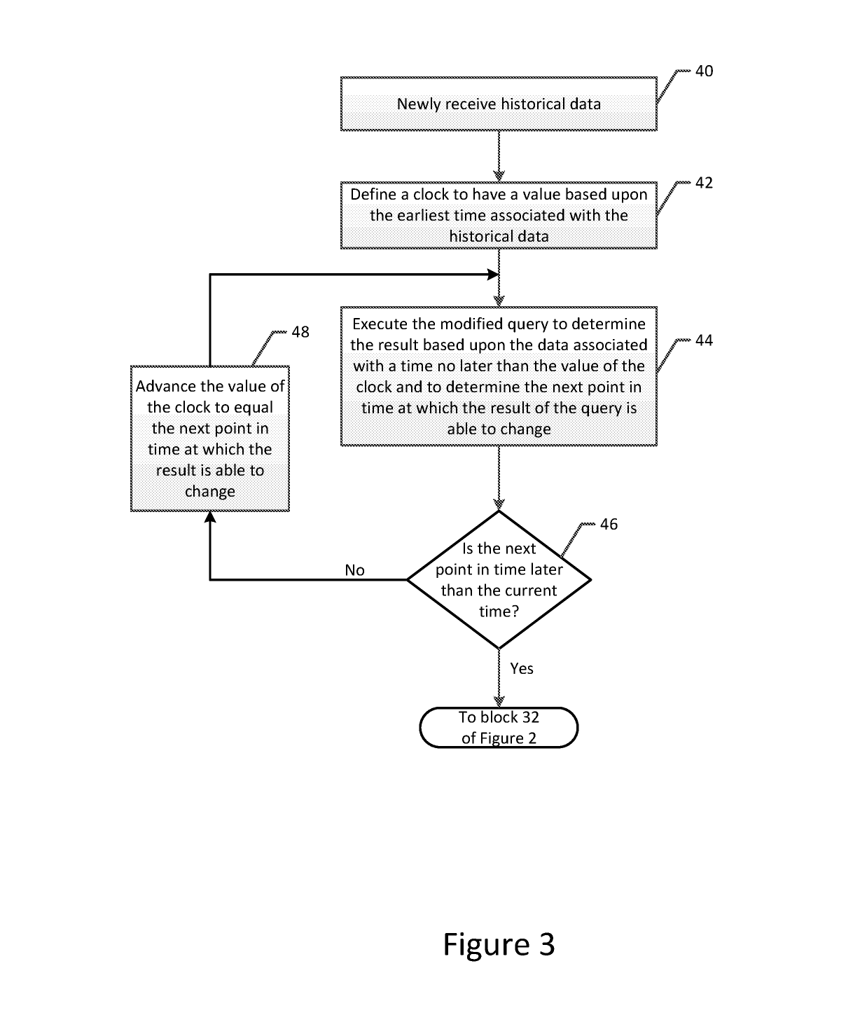

The method, computing device and computer program product of an example embodiment are not only capable of executing a query based upon current data, such as patient data derived from an electronic health record, but are also capable of executing a query based upon historical data, such as historical patient data, e.g., back dated patient data, associated with times prior to the current time. In an example embodiment depicted in FIG. 3, the computing device 10 includes means, such as the communication interface 18, the processing circuitry 12, the memory 16 or the like, for newly receiving historical data to be evaluated by the query. See block 40. In this regard, the historical data predates the current time, but it may still be of importance to determine the point(s) in time, if any, in the past when the evaluation of the query would have generated a result. The newly received historical data may be stored, such as in memory.

The computing device 10 of this example embodiment also includes means, such as the processing circuitry 12 or the like, for defining a clock to have a value based upon the time associated with the earliest of the historical data. See block 42. In this regard, each element of the historical data may be time stamped or otherwise have an associated time, such as the time at which the data was collected or otherwise captured. The computing device of this example embodiment also includes means, such as the processing circuitry or the like, for executing the modified query to determine the result based upon the data associated with a time that is no later than the value of the clock. See block 44. In this regard, the processing circuitry is configured to execute the modified query so as to operate upon the historical data that precedes the value of the clock, that is, is earlier than the value of the clock. The execution of the modified query may determine if the historical data that exists as of the value of the clock creates a result. The execution of the modified query also determines the next point in time at which the result of the query is able to change. In some embodiments, this next point in time may still be in the past such that an additional portion of the historical data is evaluated by subsequently executing the modified query at the next point in time. See block 46. This process may be repeated until all of the historical data has been evaluated and a determination is made as to whether or not the historical data generates a result when evaluated pursuant to the query.

In an instance in which the execution of the modified query with respect to the historical data generates a result where the next point in time at which the result is able to change is still in the past, the computing device 10 of an example embodiment includes means, such as the processing circuitry 12 or the like, for advancing the value of the clock to equal the next point in time at which the result of the query is able to change. See block 48. The computing device of this example embodiment also includes means, such as the processing circuitry or the like, for again executing the modified query to determine the result based upon the historical data associated with a time that is no later than the value of the clock following its advancement. See block 44. As before, the execution of the modified query again determines the next point in time at which the result of the query is able to change. The computing device of this example embodiment further includes means, such as the processing circuitry or the like, for repeating the advancement and execution until the next point in time that is determined is later than the current time, at which point in time the historical data would have been analyzed and the results, if any, of the query would have been determined. As shown by block 46, the execution of the modified query may then continue as described above with respect to FIG. 2 with the evaluation of subsequent points in time.

An example of a modified query to be executed with respect to historical data is as follows:

```
class MeasureExecutionManager {
  def execute(measure: BaseMeasure,
      personId: String,
      periodStart: Date,
      beginDate: Date,
      endDate: Date) = {
    val chart = getChart(personId)
    var executionDate = beginDate
    while (executionDate.le(endDate)) {
      val patientContext = markChartByEffectiveDate(chart, executionDate)
      val measurementPeriod = new Range(periodStart, executionDate)
      val evaluationContext = new EvaluationContext(measurementPeriod)
      val measureResults = measure.evaluate(patientContext, evaluationContext)
      persist(measureResults)
      executionDate = getNextChange(measureResults)
    }
    if (executionDate != Date.MAX) {
scheduleRecalculation(measure, personId, periodStart, executionDate)
. . .
}
```

As described above, the method, computing device and computer program product are configured to modify a query that includes at least one temporal expression so as to automatically identify the next point in time at which the query is to be evaluated. Thus, computer program code need not be separately written in order to evaluate the temporal expression(s) at each different point in time and, instead, the method, computing device and computer program product of an example embodiment may, during execution of the query at one point in time, determine the next point in time at which the query is to be executed. Thus, the query may be repeatedly executed with a method, computing device and computer program product of an example embodiment determining the next point in time at which the query is to be executed as part of the prior execution of the same query. The resulting execution of the queries may therefore be more efficient by selectively executing the queries at times at which the values of the results may change, thereby avoiding repeatedly executing the queries in an effort to determine when, if ever, the result changes.

As described above, FIGS. 2 and 3 illustrate flowcharts of a computing device 10, method, and computer program product according to example embodiments of the invention. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices 16 of a computing device and executed by processing circuitry 12, e.g., processor 14, in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowcharts support combinations of means for performing the specified functions and combinations of steps for performing the specified functions. It will also be understood that one or more blocks of the flowcharts, and combinations of blocks in the flowcharts, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processing circuitry 12 may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed is:

1. A method for modifying a query that includes at least one temporal expression to identify a point in time at which the query is to be reevaluated, the method comprising:
constructing a modified query from the query that includes at least one temporal expression, wherein the modified query that is constructed is also configured to define a manner in which a next point in time at which the result of the query is able to change is to be identified;
executing, with processing circuitry, the modified query to determine a result of the query and to also determine the next point in time at which the result of the query is able to change; and
scheduling the modified query to again be executed at the next point in time at which the result of the query is able to change.

2. A method according to claim 1 wherein the query includes a combination of two or more temporal expressions, wherein executing the modified query comprises executing the modified query so as to identify the next point in time from among a union of the points in time at which the result of the respective temporal expressions is able to change.

3. A method according to claim 1 wherein the query includes a combination of two or more temporal expressions, wherein executing the modified query comprises executing the modified query so as to identify the next point in time as an earliest point in time, subsequent to a current time, at which the result of any of the temporal expressions is able to change.

4. A method according to claim 1 wherein the query includes a combination of two or more temporal expressions, wherein executing the modified query comprises executing the modified query so as to determine the next point in time as either a minimum or a maximum of the next points in time at which the results of the respective temporal expressions are able to change based upon a manner in which the two or more temporal expressions are combined.

5. A method according to claim 1 further comprising:
newly receiving historical data to be evaluated by the query;
defining a clock to have a value based upon a time associated with an earliest of the historical data; and
executing the modified query to determine the result based upon the data associated with a time that is no later than the value of the clock, wherein execution of the modified query also determines the next point in time at which the result of the query is able to change.

6. A method according to claim 5 further comprising:
advancing the value of the clock to equal the next point in time at which the result of the query is able to change;
again executing the modified query to determine the result based upon the data associated with a time that is no later than the value of the clock following its advancement, wherein execution of the modified query also determines the next point in time at which the result of the query is able to change; and
repeating the advancement and execution until the next point in time that is determined is later than a current time.

7. A method according to claim 1 further comprising refraining from execution of the modified query following the scheduling until the next point in time at which the result of the query is able to change.

8. A computing device for modifying a query that includes at least one temporal expression to identify a point in time at which the query is to be reevaluated, the computing device comprising processing circuitry configured to:
construct a modified query from the query that includes at least one temporal expression, wherein the modified query that is constructed is also configured to define a manner in which a next point in time at which the result of the query is able to change is to be identified;
execute the modified query to determine a result of the query and to also determine the next point in time at which the result of the query is able to change; and
schedule the modified query to again be executed at the next point in time at which the result of the query is able to change.

9. A computing device according to claim 8 wherein the query includes a combination of two or more temporal expressions, wherein the processing circuitry is configured to execute the modified query by executing the modified query so as to identify the next point in time from among a union of the points in time at which the result of the respective temporal expressions is able to change.

10. A computing device according to claim 8 wherein the query includes a combination of two or more temporal expressions, wherein the processing circuitry is configured execute the modified query by executing the modified query so as to identify the next point in time as an earliest point in time, subsequent to a current time, at which the result of any of the temporal expressions is able to change.

11. A computing device according to claim 8 wherein the query includes a combination of two or more temporal expressions, wherein the processing circuitry is configured to execute the modified query by executing the modified query so as to determine the next point in time as either a minimum or a maximum of the next points in time at which the results of the respective temporal expressions are able to change based upon a manner in which the two or more temporal expressions are combined.

12. A computing device according to claim 8 wherein the processing circuitry is further configured to:
newly receive historical data to be evaluated by the query;
define a clock to have a value based upon a time associated with an earliest of the historical data; and
execute the modified query to determine the result based upon the data associated with a time that is no later than the value of the clock, wherein execution of the modified query also determines the next point in time at which the result of the query is able to change.

13. A computing device according to claim 12 wherein the processing circuitry is further configured to:
advance the value of the clock to equal the next point in time at which the result of the query is able to change;
again execute the modified query to determine the result based upon the data associated with a time that is no later than the value of the clock following its advancement, wherein execution of the modified query also determines the next point in time at which the result of the query is able to change; and
repeat the advancement and execution until the next point in time that is determined is later than a current time.

14. A computing device according to claim 8 wherein the processing circuitry is further configured to refrain from execution of the modified query following the scheduling until the next point in time at which the result of the query is able to change.

15. A computer program product comprising at least one non-transitory computer-readable storage medium for modifying a query that includes at least one temporal expression to identify a point in time at which the query is to be reevaluated, the at least one non-transitory computer-readable storage medium storing computer-executable instructions configured, when executed, to cause an apparatus to:
construct a modified query from the query that includes at least one temporal expression, wherein the modified query that is constructed is also configured to define a manner in which a next point in time at which the result of the query is able to change is to be identified;
execute the modified query to determine a result of the query and to also determine the next point in time at which the result of the query is able to change; and
schedule the modified query to again be executed at the next point in time at which the result of the query is able to change.

16. A computer program product according to claim 15 wherein the query includes a combination of two or more temporal expressions, wherein the computer-executable instructions configured to execute the modified query comprise computer-executable instructions configured to execute the modified query so as to identify the next point in time from among a union of the points in time at which the result of the respective temporal expressions is able to change.

17. A computer program product according to claim 15 wherein the query includes a combination of two or more temporal expressions, wherein the computer-executable instructions configured to execute the modified query comprise computer-executable instructions configured to execute the modified query so as to identify the next point in time as an earliest point in time, subsequent to a current time, at which the result of any of the temporal expressions is able to change.

18. A computer program product according to claim 15 wherein the query includes a combination of two or more temporal expressions, wherein the computer-executable instructions configured to execute the modified query comprise computer-executable instructions configured to execute the modified query so as to determine the next point in time as either a minimum or a maximum of the next points in time at which the results of the respective temporal expressions are able to change based upon a manner in which the two or more temporal expressions are combined.

19. A computer program product according to claim 15 wherein the computer-executable instructions are further configured to:
newly receive historical data to be evaluated by the query;
define a clock to have a value based upon a time associated with an earliest of the historical data; and
execute the modified query to determine the result based upon the data associated with a time that is no later than the value of the clock, wherein execution of the modified query also determines the next point in time at which the result of the query is able to change.

20. A computer program product according to claim 19 wherein the computer-executable instructions are further configured to:
advance the value of the clock to equal the next point in time at which the result of the query is able to change;
again execute the modified query to determine the result based upon the data associated with a time that is no later than the value of the clock following its advancement, wherein execution of the modified query also determines the next point in time at which the result of the query is able to change; and
repeat the advancement and execution until the next point in time that is determined is later than a current time.
